(19) United States
(12) Patent Application Publication
(10) Pub. No.: US 2004/0162792 A1
(43) Pub. Date: Aug. 19, 2004

(54) Optimization method for power generation cost and optimization system for power generation cost

(76) Inventors: Syouzou Satou, Iwaki (JP); Yasushi Takeda, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 10/777,977

(22) Filed: Feb. 13, 2004

(30) Foreign Application Priority Data
Feb. 17, 2003 (JP) 2003-038456

(51) Int. Cl. G06F 17/60

(52) U.S. Cl. 705/400; 705/1

(57) ABSTRACT

An object of the present invention is to offer an optimization method for power generation cost and optimization system for power generation cost that enable the transmission company to use the alternative fuel stably at the lowest possible burden.

To achieve the object, the optimization system for power generation cost 14 of the fuel information management company 93 calculates the fuel cost, taking the CO₂ emission rights trading into account, in the case of mixing the alternative fuel, such as DME, with the fossil fuel, both supplied by the fuel supply company 91 for achieving the target power generation output in the power generation plant of the transmission company 92, determines the ratio of mixture of the alternative fuel at which the fuel cost is lower than in the case of using the fossil fuel only, forms an operating plan for operating the plant at the ratio of mixture, and sends the plan to the transmission company 92. In addition, the system charges the price, which is the difference between the fuel costs in the case of using the fossil fuel only and mixing the alternative fuel with the fossil fuel, multiplied by a pre-specified coefficient, as a service charge for the merit the transmission company 92 has enjoyed.

The transmission company 92 can use the alternative fuel at the lowest possible burden.

### BACKGROUND OF THE INVENTION

1. Field of the Invention

The present invention relates to a support system for generating company of the transmission company who generates and supplies electric power, using fossil fuel, particularly to an optimization method for power generation cost and optimization system for power generation cost for lowering the power generation cost and also for reducing the hazardous substance emission amount into the environment, both by utilizing fossil fuel.

2. Prior Art

Fossil fuel such as coal, heavy oil and light oil, of which carbon equivalent is relatively high, has been used as the fuel for power generation.

Existing power generation plants have expanded the use of alternative fuel, such as non-fossil fuel, so as to reduce CO₂ that is generated in burning fossil fuel.

With regard to the CO₂ issue, a trading method for CO₂ emission rights has been proposed (for example, refer to Reference Patent 1). Buying and selling transactions of the CO₂ emission rights are made on the Internet. The buying and selling price of the CO₂ emission rights trading is either determined by CO₂ emission rights trading center or decided through the floating exchange rate system in accordance with actual demand and supply.

With this conventional method, if the CO₂ emission amount of an entity (such as nation, local government, enterprise, shop, and individual household) is in excess of the emission amount according to the CO₂ emission rights the entity has already acquired, the CO₂ emission rights trading center sends to the entity an instruction to acquire additional CO₂ emission rights covering the excess. On the contrary, if, for example, the entity has generated electric power using the sunlight, the CO₂ emission rights trading center gives the entity the CO₂ emission rights corresponding to the quantity of the electric power generation.

The document, however, does not describe concrete method for optimizing the cost or device for controlling the CO₂ emission amount in a power generation plant.

Japanese Application Patent Laid-Open Publication No. 2001-306839 (pages 5-7, FIGS. 3 through 9)

### SUMMARY OF THE INVENTION

(Problems to be Solved by the Invention)

In order to effectively reduce CO₂ to be emitted from a power generation plant, it is favorable to mix clean alternative fuel, including gases with relatively low carbon equivalent, liquefied natural gas (LNG) produced from the gases, and dimethyl ether (DME), into the fossil fuel. That is to say, in order to promote the preservation of the global environment, it is desirable to reduce the use of fossil fuel and increase the mixture rate of clean alternative fuel.

However, if a transmission company mixes the above alternative fuel in the power generation plant that is using fossil fuel, their cost bearing may possibly become greater than in the case of continuous use of the fossil fuel only. At present, demand for the alternative fuel is low and the price of the alternative fuel is unstable. The alternative fuel may sometimes be supplied at a lower price than the conventional fossil fuel and sometimes be supplied at a higher price. As described above, mixture use of the alternative fuel produces a merit for the transmission company in terms of the environment but, on the other hand, the fuel cost is unstable and so they must make a definite decision to dare to start using the alternative fuel.

The object of the present invention is to supply an optimization method for power generation cost and optimization system for power generation cost as well as support system for generating company so that the transmission company can stably use the alternative fuel at the lowest possible burden.

(Means for Solving the Problems)

In order to achieve the above object, the present invention proposes an optimization method for power generation cost, optimization system for power generation cost and support system for generating company which assume the mixture rate of alternative fuel and calculates the fuel cost for achieving a target power generation output based on, at least, the fossil fuel price, alternative fuel price, electric power price, and CO₂ emission rights price for trading, calculates the fuel cost in the case of using fossil fuel only, and determines the ratio of mixture of the alternative fuel at which the fuel cost in the case of mixing the alternative fuel is lower than the fuel cost in the case of using the fossil fuel only.

The procedure of assuming the mixture rate of the alternative fuel and calculating the fuel cost forms the zero-order synthesis fuel invest plan that specifies the initial mixture rate of the fossil fuel and alternative fuel, calculates the fuel cost based on the fossil fuel price, alternative fuel price, electric power price, and CO₂ emission rights price for trading, judges whether the result of the fuel cost calculation has reached the optimum cost, and, if not yet reached, modifies the nth-order synthesis fuel invest plan and forms the (n+1)th-order synthesis fuel invest plan, and re-inputs the plan into the calculating means, and, if the result has reached the optimum cost, outputs an operating plan meeting the fuel cost.

The procedure of assuming the mixture rate of the alternative fuel and calculating the fuel cost calculates;

in the case of CO₂ emission rights purchase,

Fuel cost=Alternative fuel consumption×Unit for alternative fuel+Fossil fuel consumption×Unit for fossil fuel+Emission rights trading displacement×Unit for emission rights trading; and

in the case of CO₂ emission rights sale,

Fuel cost=Alternative fuel consumption×Unit for alternative fuel+Fossil fuel consumption×Unit for fossil fuel−Emission rights trading displacement×Unit for emission rights trading

### BRIEF DESCRIPTION OF THE DRAWINGS

FIG. 1 is block diagram showing the schematic flow of the support system for generating company, including the optimization system for power generation cost according to the present invention.

FIG. 2 is diagram showing the schematic flow of the power generation plant equipment of the transmission company 92.

FIG. 3 is block diagram showing an example of the construction of the optimization system for power generation cost 14 at the fuel information management company 93.

FIG. 4 is flowchart showing an example of the processing procedure of the optimization system for power generation cost 14.

FIG. 5 is diagram showing the relationships of the use rate of the alternative fuel, CO₂ emission amount, and cost, based on the condition that the target quantity of the electric power generation is constant, “unit for fossil fuel<unit for alternative fuel” (difference in the units is small) applies, and that the unit for the CO₂ emission rights trading is low.

FIG. 6 is diagram showing the relationships of the use rate of the alternative fuel, CO₂ emission amount, and cost, based on the condition that the target quantity of the electric power generation is constant, “unit for fossil fuel<unit for alternative fuel” (difference in the units is small) applies, and that the unit for the CO₂ emission rights trading is high.

FIG. 7 is diagram showing the relationships of the use rate of the alternative fuel, CO₂ emission amount, and cost, based on the condition that the target quantity of the electric power generation is constant, “unit for fossil fuel<unit for alternative fuel” (difference in the units is big) applies, and that the unit for the CO₂ emission rights trading is low.

FIG. 8 is diagram showing the relationships of the use rate of the alternative fuel, CO₂ emission amount, and cost, based on the condition that the target quantity of the electric power generation is constant, “unit for fossil fuel<unit for alternative fuel” (difference in the units is big) applies, and that the unit for the CO₂ emission rights trading is high.

FIG. 9 is diagram showing the relationships of the use rate of the alternative fuel, CO₂ emission amount, and cost based on the condition that the target quantity of the electric power generation is constant, “unit for fossil fuel≧unit for alternative fuel” (difference in the units is small) applies, and that the unit for the CO₂ emission rights trading is high.

FIG. 10 is block diagram showing the flow of the fuel, information and payment in the support system for generating company according to the present invention.

### DETAILED DESCRIPTION OF THE INVENTION

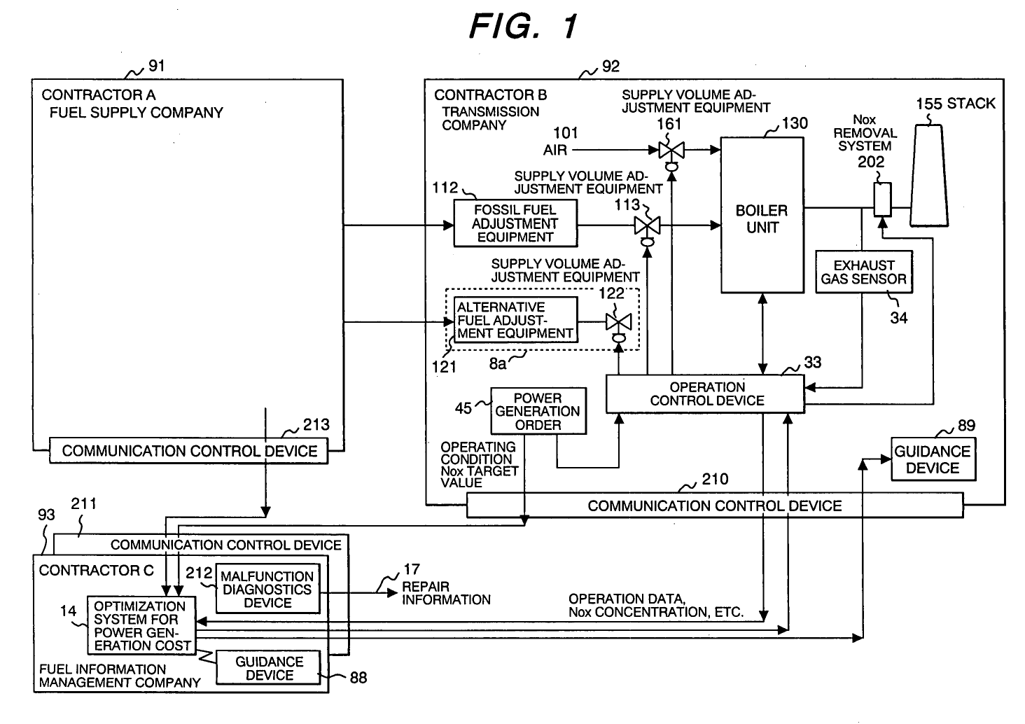

Preferred embodiments of the optimization method for power generation cost and optimization system for power generation cost according to the present invention are described hereunder, using FIGS. 1 to 10.

### Embodiment 1

FIG. 1 is a block diagram showing the schematic flow of the support system for generating company, including the optimization system for power generation cost according to the present invention.

The support system for generating company of this embodiment comprises a fuel supply company 91, transmission company 92, and fuel information management company 93. The fuel supply company 91, transmission company 92, and fuel information management company 93 are connected with each other by and through a communication control device 213, communication control device 210, communication control device 211 and network. For the activation of market and stable supply of the alternative fuel, there can be multiple fuel supply companies 91, power transmission companies 92, and fuel information management companies 93, respectively.

The fuel supply company 91 is a company who sells the fossil fuel and the alternative fuel, such as DME, that substitutes for the fossil fuel.

The transmission company 92 is a company who generates electric power using the fossil fuel and alternative fuel and sells the generated electric power.

The power generation plant of the transmission company 92 comprises a power generation equipment including a boiler unit 130, fossil fuel adjustment equipment 112, supply volume adjustment equipment 113 for regulating the volume of the fossil fuel supplied from the fossil fuel adjustment equipment 112 to the boiler unit 130, alternative fuel adjustment equipment 121, supply volume adjustment equipment 122 for regulating the volume of the alternative fuel supplied to the boiler unit 130, supply volume adjustment equipment 161 for regulating the volume of the air 101 supplied to the boiler unit 130, exhaust gas sensor 34 for measuring the CO₂ and NOx concentration in the exhaust gas of the boiler unit 130, NOx removal system 202 for supplying ammonia to the exhaust gas to reduce NOx to N₂, and stack 155 for discharging the exhaust gas after NOx removal.

The power plant of the transmission company 92 is equipped with a power generation ordering means 45 for outputting the operating condition, CO₂ target value, and power generation order, operation control device 33 for controlling the supply volume adjustment equipment 113, supply volume adjustment equipment 122, supply volume adjustment equipment 161 and boiler unit 130, communication control device 210, and guidance device 88.

The fuel information management company 93 is equipped with a communication control device 211, malfunction diagnostics device 212, guidance device 88, and the optimization system for power generation cost 14 of the present invention.

The optimization system for power generation cost 14 of the fuel information management company 93 received data, including the price, stock volume, deadline, composition, and calorific heating value of the fossil fuel and alternative fuel, from the fuel supply company 91.

The optimization system for power generation cost 14 receives from the transmission company 92 the operation data, such as the combustion temperature of the boiler unit 130, CO₂ and NOx concentration data detected by the exhaust gas sensor 34, and target power generation output outputted from the power generation ordering means 45.

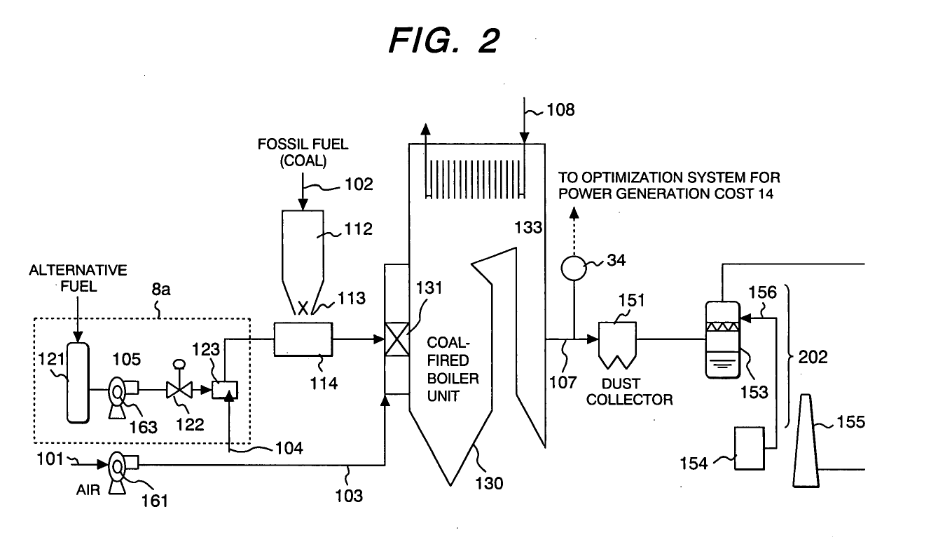

FIG. 2 is a diagram showing the schematic flow of the power generation plant equipment of the transmission company 92.

Coal 102, which is the fossil fuel delivered by the fuel supply company 91, is stored in the fossil fuel adjustment equipment 112, and then supplied to the coal crushers and grinding mill 114. The pulverized coal is transferred to the burner 131 of the coal-fired boiler unit.

On the other hand, the alternative fuel 105 is pumped out from the alternative fuel adjustment equipment (storage tank) 121 by a pump 163. The volume of the alternative fuel 105 to be mixed is in the range from 0 to 50% of the supply volume of the coal by weight ratio. The mixed alternative fuel together with the pulverized coal 102 is supplied to the burner 131 of the boiler unit 130. For mixing the alternative fuel 105, a suitable method such as gas supply system, spray combustion method or solid reserve method shall be employed according to the type of the alternative fuel 105 to be supplied.

The alternative fuel 105, supplied together with the pulverized coal 102 into the burner 131, decomposes as the coal 105 burns and so the combustion gas temperature increases and generates hydroperoxyradical (HOO). HOO oxidizes NO, resulting from the combustion, to NO₂. NO₂, which is more active than NO, is reduced to N₂ by the hydrocarbon, CO, H₂, cyanogens HCN, ammonia NH₃ and other related compounds and radicals coexisting in the gas.

If DME is mixed as the alternative fuel, the generated alkylradical CH₃OCH₂ contributes to the reduction of NO₂.

The side wall of the coal-fired boiler unit 130 has a water-cooled wall structure consisting of water-cooled pipes, and the heat of combustion is absorbed by the water or steam flowing in the water-cooled pipes.

The exhaust gas sensor 34 detects the CO₂ concentration in the exhaust gas 107 discharged from the coal-fired boiler unit 130.

Dust in the exhaust gas is removed by a dust collector 151 and NOx is removed by the NOx removal system 202. To be concrete, ammonia supplied from an ammonia supply apparatus 154 is sprayed into a NOx removal tower 153 so as to have NOx in the exhaust gas react with the ammonia to-reduce to N₂. The exhaust gas after the NOx removal treatment is discharged into the air from the stack 155.

Each fossil fuel adjustment equipment 112 and alternative fuel adjustment equipment 121 is equipped with a sensor for detecting the consumption. The ammonia supply apparatus 154 of the NOx removal system 202 is equipped with a sensor for detecting the ammonia consumption.

The output of each sensor is outputted from the operation control device 33 to the optimization system for power generation cost 14 of the fuel information management company 93.

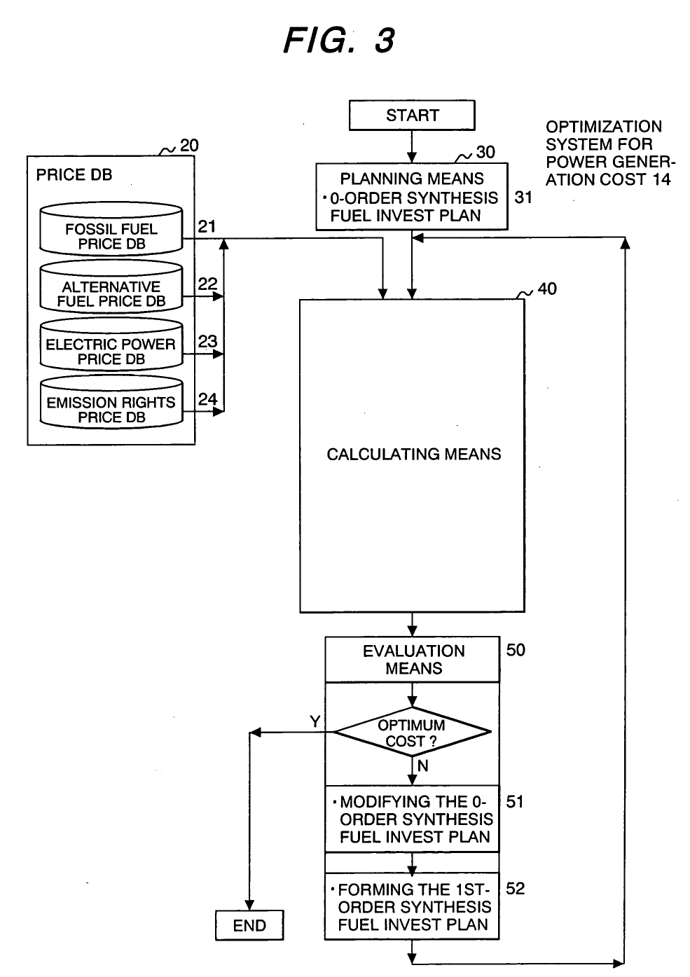

FIG. 3 is a block diagram showing an example of the construction of the optimization system for power generation cost 14 at the fuel information management company 93.

The optimization system for power generation cost 14 comprises a price database (DB) 20, planning means 30, calculating means 40, and evaluation method 50. The price DB 20 includes a fossil fuel price DB 21, alternative fuel price DB 22, electric power price DB 23, and CO₂ emission rights price DB 24.

The planning means 30 forms the zero-order, that is, initial synthesis fuel invest plan. In the initial synthesis fuel invest plan, the parameters of which period and quantity are modifiable are set to specific values for a specified period of the operation of the power generation plant and the parameters of which proportional coefficient are modifiable are set to specific quantities in proportion to the ratio of load change, making reference to the past operation results in other power generation plants.

With the optimization method for power generation cost according to the present invention, the fuel cost in the case of using the fossil fuel and alternative fuel mixture as the fuel for achieving the target power generation output is calculated, using each unit for the fossil fuel and alternative fuel, and the ratio of invest of the alternative fuel, at which the fuel cost is lower than in the case of using the fossil fuel only, is determined, taking into account the CO₂ emission rights trading.

The transmission company 92 calculates the fuel cost in the case of using the fossil fuel only and the fuel cost in the case of investing the alternative fuel into the fossil fuel at the above ratio of mixture, and calculates a cost that is the difference between the two fuel costs multiplied by a pre-specified coefficient.

In the above calculation, the optimization system for power generation cost 14 shall have calibrated the characteristic formula of the plant for calculating the CO₂ emission amount, which is defined according to the fuel to be used and the volume of the air, based on the actual measurement.

In other words, the calculating means 40 executes calculations for minimizing the fuel cost based on the data such as the fuel prices. The calculating means 40 and the processing procedure therein, which have been calibrated beforehand based on the actual measurement, calculate the cost based on the CO₂ emission rights to be consumed, fuel consumption, and quantity of the electric power to be sold, making reference to the one-year actual operation data or predicted operation data of an existing plant.

The calculating means 40 receives the zero-order synthesis fuel invest plan from the planning means 30 and reads out the fossil fuel price 21, alternative fuel price 22, electric power price 23 and CO₂ emission rights price 24 from the price DB 20. The calculating means 40 then calculates the fuel cost based on the present parameter information, fossil fuel price 21, alternative fuel price 22, electric power price 23, CO₂ emission rights price 24 and each piece of data including the fossil fuel consumption, alternative fuel consumption, and quantity of the electric power to be sold.

The calculating means 40 may employ fossil fuel price reduction coefficient, alternative fuel price reduction coefficient, and alternative fuel conversion coefficient in addition to the basic parameters such as the present unit for the fossil fuel and present unit for the alternative fuel. The alternative fuel conversion coefficient is a coefficient defined as “Alternative fuel conversion coefficient=Calorific heating value of fossil fuel/Calorific heating value of alternative fuel”, representing the ratio of the calorific heating value of the fossil fuel over the calorific value of the alternative fuel, both sold by the fuel supply company 91. The fossil fuel price reduction coefficient and alternative fuel price reduction coefficient are the price discount coefficient, which is set to become greater as the volume ordered increases.

The evaluating method 50 judges whether the result of the fuel cost calculation has reached the optimum cost and, if not yet reached, modifies the zero-order synthesis fuel invest plan and forms the 1st-order synthesis fuel invest plan, and re-inputs the plan into the calculating means 40. This procedure is repeated until the result has reached the optimum cost.

If the result of the fuel cost calculation has reached the optimum cost, the optimization system for power generation cost 14 sends the most suitable invest plan of the alternative fuel for achieving the optimum cost to the operation control device 33 of the transmission company 92. The operation control device 33 mixes the alternative fuel with the fossil fuel for generating electric power according to the received most suitable invest plan.

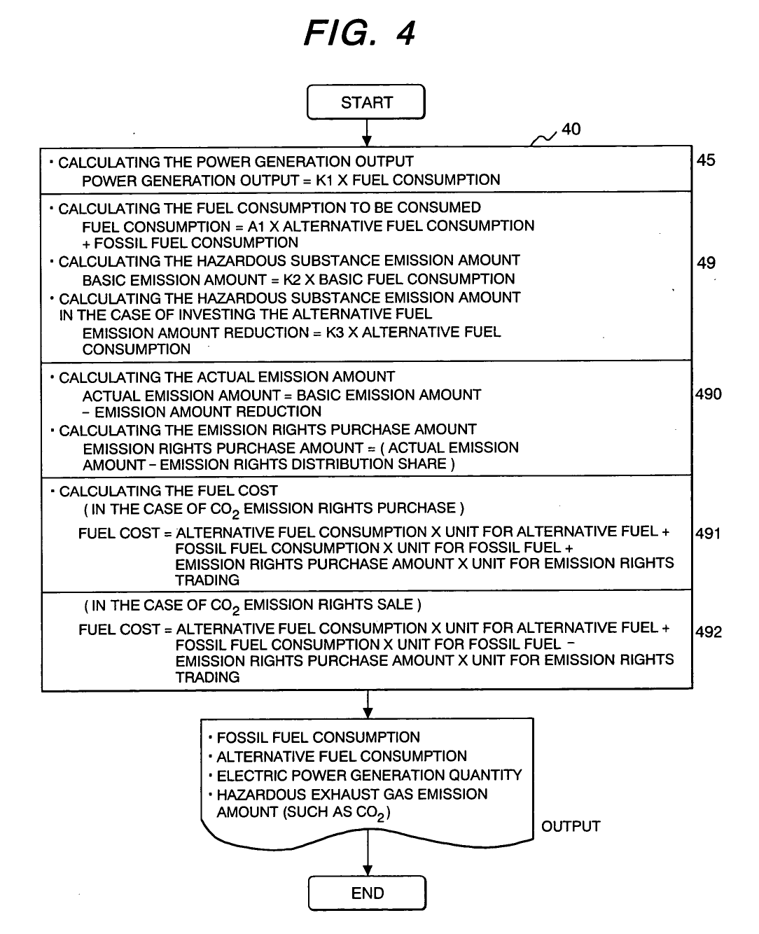

FIG. 4 is a flowchart showing an example of the processing procedure of the optimization system for power generation cost 14.

The concrete calculation method and an example of calculation formula for minimizing the fuel cost of a power generation plant according to the present invention are explained hereunder. In the following description, the integrating value of the electric power output obtained by operating a power generation plant for a specified length of period is called the power generation output.

Step 45: Assuming that the energy conversion efficiency of a power generation plant does not vary by the type of fuel and is stable even if the load fluctuates, the generation power output can be expressed as:

Generation power output=f1(Fuel consumption)=K1×Fuel consumption (1)

where, f1 represents a function and K1 is a proportional constant.

If the fuel consumption is expressed not by weight or volume but by the calorific heating value to be invested per unit time to the plant, for example in a unit of kWh/year, the proportional constant K1 represents the power generation efficiency itself. Herein, the fuel consumption is calculated as:

Fuel consumption=Alternative fuel consumption+Fossil fuel consumption (2)

that is, the sum of the alternative fuel consumption and the fossil fuel consumption.

In reality, no such simple relationship as expressed by Formula (2) holds true but, because the power generation efficiency of the plant varied due to the use of the alternative fuel, the fuel consumption is expressed as:

Fuel consumption=A1×Alternative fuel consumption+Fossil fuel consumption (2)

where, A1 is a variable that bases on the variation in the efficiency of the power generation plant resulting from investing the alternative fuel.

Step 49: Next, the hazardous exhaust gas emission amount and CO₂ emission rights are examined. Assuming that the hazardous substance basic emission amount, based on an assumption that the fuel consumption is 100% fossil fuel, is not affected by the operating mode or load level but is proportional to the amount of injections of the fossil fuel, the formula below holds true:

Basic emission amount=f2(Basic fuel consumption)=K2×Basic fuel consumption (3)

where, the basic fuel consumption is the fossil fuel consumption on an assumption that the fuel consumption is 100% fossil fuel. f2 represents a function and K2 is a proportional constant that bases on the special characteristic of the plant.

Next, assuming that the reduction of the hazardous substance emission amount in the case of investing the fossil fuel is not affected by the operating mode or load level but is proportional to the alternative fuel consumption, the formula below holds true:

Emission amount reduction=f3(Alternative fuel consumption)=K3×Alternative fuel consumption (4)

where, f3 represents a function and K3 is a proportional constant that bases on the special characteristic of the plant.

Step 490: The actual hazardous substance emission amount is calculated as the difference between (3) and (4), that is:

Actual emission amount=Basic emission amount−Emission amount reduction (5)

The CO₂ emission rights purchase amount can be expressed as a function of the actual emission amount:

Emission rights purchase amount=f4 (Emission amount)

and can be defined as,

in the case of Actual emission amount>Emission rights distribution share:=(Actual emission amount−Emission rights distribution share)

and, in the case of Actual emission amount≦Emission rights distribution share:=0 (6)

Herein, the CO₂ emission rights distribution share means the hazardous substance emission amount permitted under the distributed free-of-charge CO₂ emission rights.

Steps 491 and 492: The fuel cost associated with the purchase and sale of the fuel and CO₂ emission rights is calculated, taking into account these parameters and units for the alternative fuel, fossil fuel and CO₂ emission rights. Since the fuel cost is the sum of the products of the units for the alternative fuel and fossil fuel and the consumptions thereof, respectively, and product of the unit for the CO₂ emission rights trading and the purchase displacement, the formulas below are obtained.

Step 491: In the case of CO₂ emission rights purchase,

Fuel cost=Alternative fuel consumption×Unit for alternative fuel+Fossil fuel consumption×Unit for fossil fuel+Emission rights trading displacement×Unit for emission rights trading (7); and

Step 492: In the case of CO₂ emission rights sale,

Fuel cost=Alternative fuel consumption×Unit for alternative fuel+Fossil fuel consumption×Unit for fossil fuel−Emission rights trading displacement×Unit for emission rights trading (8)

Each unit for the alternative fuel, fossil fuel and CO₂ emission rights fluctuates like the stock. It is known that the unit for the fossil fuel drops in summer and rises in winter.

Besides, in the U.S.A., it is known that the CO₂ emission rights becomes short in autumn because it is mostly consumed in summer, which is the season with high electric power demand, and so the CO₂ emission rights price is thought to jump up in the season from autumn to winter.

There is a limitation to the storage volume of the fuel. On the other hand, since the CO₂ emission rights is a commercial security and there is no limitation to the purchase, a strategy of buying the emission rights while it is less expensive becomes available.

For the above reasons, in order to evaluate precise profitability, it is necessary to execute the calculations in consideration of the non-linear characteristics of the Formulas (1) through (8) and performance of the plant.

For example, let us assume that the power generation output by the Formula (1) is the one-year integrating value. There is no such plant that can determine their one-year power generation output in advance, and their power generation output is the accumulated total of the electric power output that has been generated in accordance with the fluctuation of the electric power demand of the users.

With the optimization method for power generation cost of the present invention, therefore, the fuel cost and emission amount are summed up, for example as of the end of June, based on the past operation result of the year, and then the purchase volume of the alternative fuel and purchase displacement of the CO₂ emission rights in the coming months are decided, taking into account the price prediction and electric power demand prediction through to December.

In executing these calculations, the CO₂ emission rights distribution share is a preset value and the power generation output, unit for the alternative fuel, and unit for the fossil fuel are the inputs as predicted value.

The parameters to be operated for minimizing the fuel cost are the alternative fuel consumption and CO₂ emission amount. The CO₂ emission rights purchase displacement is determined by calculation and the unit for the CO₂ emission rights trading used for the calculation can be the price in a season when the price is predicted to become least expensive.

Applicable optimization method includes the mathematical method, such as Newton method and Steepest Descent Method, and technique such as genetic algorithm.

The items to be outputted as the result of the calculation by the above calculation formulas and calculation methods shall be four items: fossil fuel consumption, synthesis fuel consumption, quantity of the electric power to be generated, and hazardous exhaust gas emission amount (for example, CO₂).

Based on the cost calculations and-output results, the initially formed zero-order synthesis fuel invest plan is reviewed and modified, and then the 1st-order synthesis fuel invest plan is formed and similar calculations as above are executed. The above treatments are repeated so as to search an invest plan of the alternative fuel in which the fuel cost becomes the lowest possible.

In the above cost calculation, the price obtained by multiplying the fuel cost reduction, which, as compared to the case where the electric power is generated using the fossil fuel only, has been achieved as a result that the transmission company 92 operates the plant according to the preset synthesis fuel invest plan, by a pre-specified coefficient can be confirmed as the merit charge for a fuel price curtailment that has been achieved as a result that the transmission company 92 has accepted the operating plan.

In order to balance the cost reduction by using the alternative fuel with the expenses on the CO₂ emission rights, it is necessary to minimize the expenses on the CO₂ emission rights while the invest amount of the alternative fuel is kept minimum and the emission amount of the hazardous substance is also kept minimum.

Under the present circumstances in Japan, since there is no regulation table relating to the expense on the CO₂ emission rights and the price of the alternative fuel, such as DME, is very much fluctuating, the emission amount and fuel cost need be set in consideration of possible fluctuation.

The CO₂ emission rights is granted from the government to each transmission company 92 as the initial distribution share according to the quantity of the electric power generation of each company. The initially distributed CO₂ emission rights is free of charge. For any consumption consumed in excess of the initial distribution share, the transmission company 92 must pay the cost for the excess. That is, the company must buy necessary CO₂ emission rights additionally.

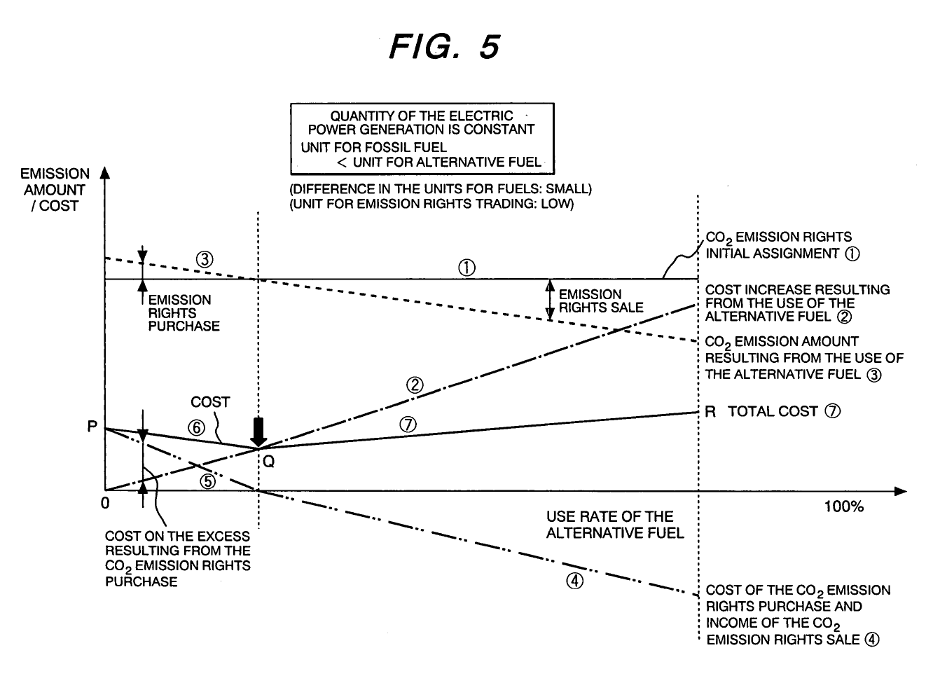

In order to cope with these problems, as shown in FIGS. 5 through 9, the present invention finds out the point at which the fuel cost becomes minimum, based on the relationship between the cost of the alternative fuel consumption and cost of the CO₂ emission rights consumption, taking into account the variable parameters including the price of the alternative fuel, such as DME, CO₂ emission rights, and emission amount.

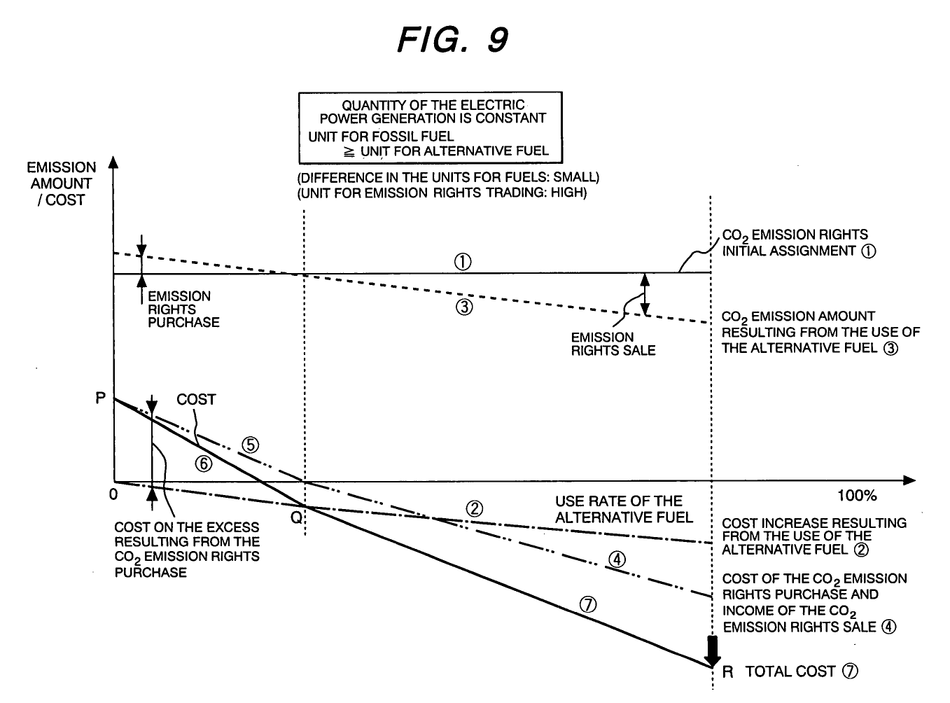

FIG. 5 to FIG. 9 are based on a precondition that the target quantity of the electric power generation is constant. FIG. 5 to FIG. 8 show the examples of searching the fuel cost in the case that the unit for the alternative fuel is higher than the unit for the fossil fuel, and FIG. 9 shows an example of searching the fuel cost in the case that the unit for the fossil fuel is higher than the unit for the alternative fuel.

With regard to the five patterns (1) to (5) where either CO₂ emission rights purchase or sale is necessitated, preconditions and detailed treatments in each pattern are described hereunder.

### Embodiment 1

In the case that “unit for fossil fuel<unit for alternative fuel” (difference in the units is small) applies and the unit for the CO₂ emission rights trading is low:

FIG. 5 is a diagram showing the relationships of the CO₂ emission rights trading initial assignment <1>, cost increase resulting from the use of the alternative fuel <2>, CO₂ emission amount resulting from the use of the alternative fuel <3>, income of the CO₂ emission rights purchase and sale <4>, cost on the excess resulting from the CO₂ emission rights purchase <5>, cost <6>, and total cost <7>based on the condition that the target quantity of the electric power generation is constant, “unit for fossil fuel<unit for alternative fuel” (difference in the units is small) applies, and that the unit for the CO₂ emission rights trading is low. The CO₂ emission rights trading initial assignment <1> is constant.

Since the difference in the units for the fossil fuel and alternative fuel is small, the cost <2>, if the cost increase by the use of the alternative fuel is set higher in consideration of the difference in the units, increases as the use rate of the alternative fuel increases, exhibiting a rising trend.

The CO₂ emission amount <3> resulting from investing the alternative fuel is calculated by the processing procedure shown in FIGS. 3 and 4, and exhibits a falling curve <3> to the contrary to the cost <2>.

If the CO₂ emission amount <3> resulting from investing the alternative fuel exceeds the CO₂ emission rights trading initial assignment <1>, it becomes necessary to purchase additional CO₂ emission rights. The cost needed for this purchase is as shown by the curve <5>.

On the other hand, if the CO₂ emission amount <3> resulting from investing the alternative fuel does not exceed the CO₂ emission rights trading initial assignment <1>, the unused emission rights (surplus) can be utilized for the CO₂ emission rights sale. The cost needed for this sale is as shown by the curve <4>.

The cost resulting from the difference in the units for the fuel and difference in the units for the CO₂ emission rights under these circumstances are represented by the curve <6> when the CO₂ emission rights purchase cost is taken into account by adding the above increased and decreased costs <4> and <5> to the cost increase resulting from the use of the alternative fuel <2>, and by the curve <7> when the CO₂ emission rights sale cost is taken into account.

Using the fuel cost calculation formulas given by the steps 491 and 492 in the processing procedure shown in FIG. 4, the position at which the fuel cost becomes the minimum can be found at the lowest point Q of a line PQR on the curves <6> and <7> in FIG. 5.

### Embodiment 2

In the case that “unit for fossil fuel<unit for alternative fuel” (difference in the units is small) applies and the unit for the CO₂ emission rights trading is high:

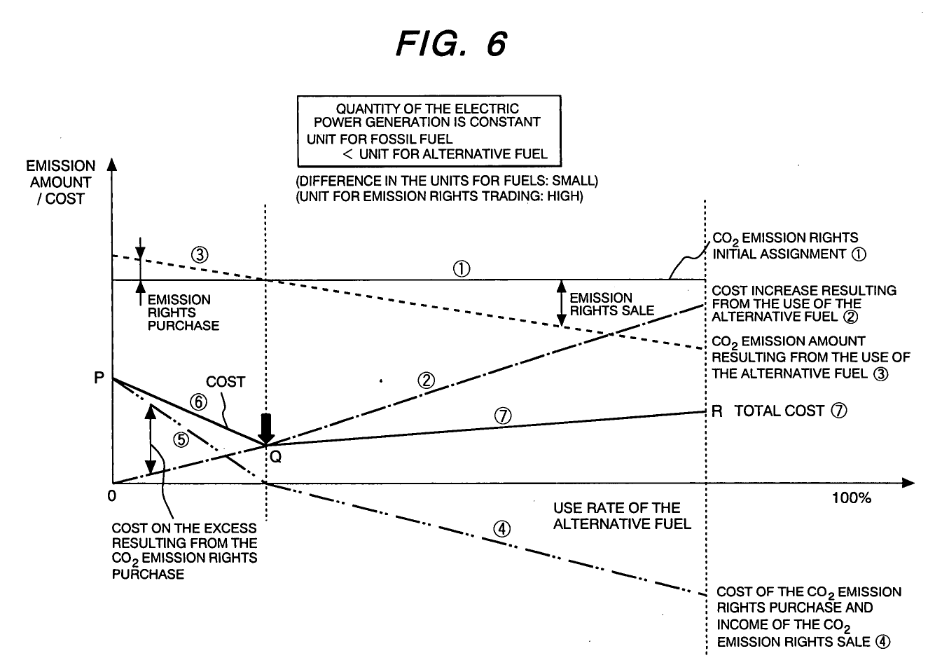

FIG. 6 is a diagram showing the relationships of the CO₂ emission rights trading initial assignment <1>, cost increase resulting from the use of the alternative fuel <2>, CO₂ emission amount resulting from the use of the alternative fuel <3>, income of the CO₂ emission rights purchase and sale <4>, cost on the excess resulting from the CO₂ emission rights purchase <5>, cost <6>, and total cost <7> based on the condition that the target quantity of the electric power generation is constant, “unit for fossil fuel<unit for alternative fuel” (difference in the units is small) applies, and that the unit for the CO₂ emission rights trading is high. The CO₂ emission rights trading initial assignment <1> is constant.

Since the difference in the units for the fossil fuel and alternative fuel is small, the cost <2>, if the cost increase by the use of the alternative fuel is set higher in consideration of the difference in the units, increases as the use rate of the alternative fuel increases, exhibiting a rising trend.

The CO₂ emission amount <3> resulting from investing the alternative fuel is calculated by the processing procedure shown in FIGS. 3 and 4, and exhibits a falling curve <3> to the contrary to the use ratio of the alternative fuel.

If the CO₂ emission amount <3> resulting from investing the alternative fuel exceeds the CO₂ emission rights trading initial assignment <1>, it becomes necessary to purchase additional CO₂ emission rights. The cost needed for this purchase is as shown by the curve <5>.

On the other hand, if the CO₂ emission amount <3> resulting from investing the alternative fuel does not exceed the CO₂ emission rights trading initial assignment <1>, the unused emission rights (surplus) can be utilized for the CO₂ emission rights sale. The cost needed for this sale is as shown by the curve <4>.

The cost resulting from the difference in the units for the fuel and difference in the units for the CO₂ emission rights under these circumstances are represented by the curve <6> when the CO₂ emission rights purchase cost is taken into account by adding the above increased and decreased costs <4> and <5> to the cost increase resulting from the use of the alternative fuel <2>, and by the curve <7> when the CO₂ emission rights sale cost is taken into account.

Using the fuel cost calculation formulas given by the steps 491 and 492 in the processing procedure shown in FIG. 4, the position at which the fuel cost becomes the minimum can be found at the lowest point Q of a line PQR on the curves <6> and <7> in FIG. 6.

### Embodiment 3

In the case that “unit for fossil fuel<unit for alternative fuel” (difference in the units is big) applies and the unit for the CO₂ emission rights trading is low:

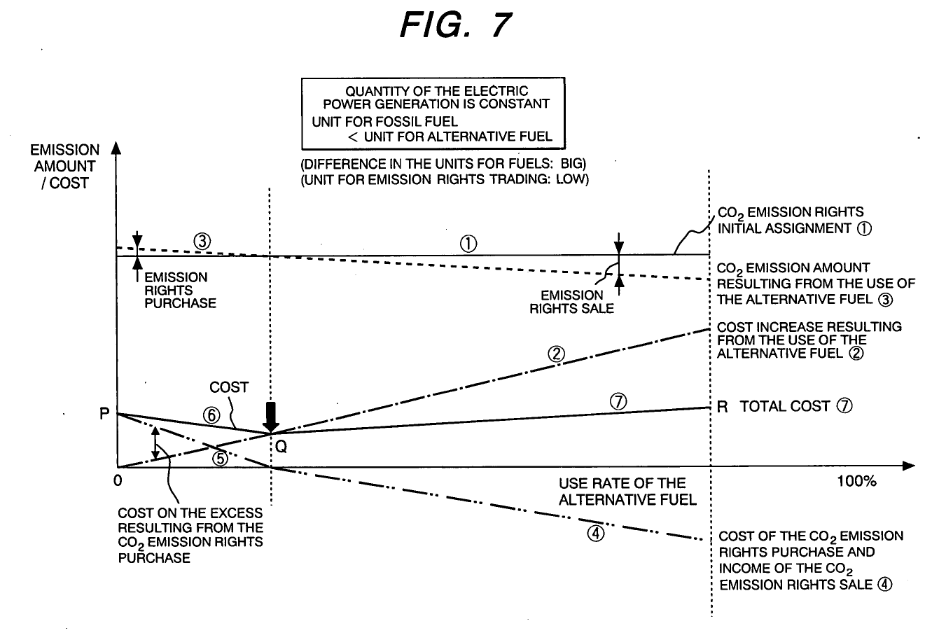

FIG. 7 is a diagram showing the relationships of the CO₂ emission rights trading initial assignment <1>, cost increase resulting from the use of the alternative fuel <2>, CO₂ emission amount resulting form the use of the alternative fuel <3>, income of the CO₂ emission rights purchase and sale <4>, cost on the excess resulting from the CO₂ emission rights purchase <5>, cost <6>, and total cost <7> based on the condition that the target quantity of the electric power generation is constant, “unit for fossil fuel<unit for alternative fuel” (difference in the units is big) applies, and that the unit for the CO₂ emission rights trading is low. The CO₂ emission rights trading initial assignment <1> is constant.

Since the difference in the units for the fossil fuel and alternative fuel is big, the cost <2>, if the cost increase by the use of the alternative fuel is set lower in consideration of the difference in the units, increases as the use rate of the alternative fuel increases, exhibiting a more gently rising trend than in FIG. 5 and FIG. 6.

The CO₂ emission amount <3> resulting from investing the alternative fuel is calculated by the processing procedure shown in FIGS. 3 and 4, and exhibits a falling curve <3> to the contrary to the use ratio of the alternative fuel.

If the CO₂ emission amount <3> resulting from investing the alternative fuel exceeds the CO₂ emission rights trading initial assignment <1>, it becomes necessary to purchase additional CO₂ emission rights. The cost needed for this purchase is as shown by the curve <5>.

On the other hand, if the CO₂ emission amount <3> resulting from investing the alternative fuel does not exceed the CO₂ emission rights trading initial assignment <1>, the unused emission rights (surplus) can be utilized for the CO₂ emission rights sale. The cost needed for this sale is as shown by the curve <4>.

The cost resulting from the difference in the units for the fuel and difference in the units for the CO₂ emission rights under these circumstances are represented by the, curve <6> when the CO₂ emission rights purchase cost is taken into account by adding the above increased and decreased costs <4> and <5> to the cost increase resulting from the use of the alternative fuel <2>, and by the curve <7> when the CO₂ emission rights sale cost is taken into account.

Using the fuel cost calculation formulas given by the steps 491 and 492 in the processing procedure shown in FIG. 4, the position at which the fuel cost becomes the minimum can be found at the lowest point Q of a line PQR on the curves <6> and <7> in FIG. 7.

### Embodiment 4

In the case that “unit for fossil fuel<unit for alternative fuel” (difference in the units is big) applies and the unit for the CO₂ emission rights trading is high:

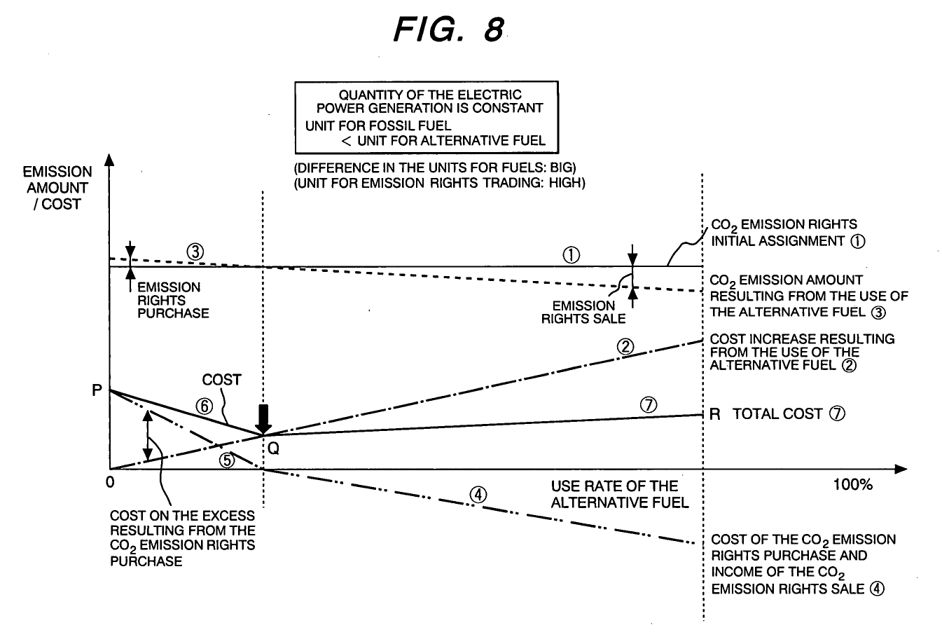

FIG. 8 is a diagram showing the relationships of the CO₂ emission rights trading initial assignment <1>, cost increase resulting from the use of the alternative fuel <2>, CO₂ emission amount resulting from the use of the alternative fuel <3>, income of the CO₂ emission rights purchase and sale <4>, cost on the excess resulting from the CO₂ emission rights purchase <5>, cost <6>, and total cost <7> based on the condition that the target quantity of the electric power generation is constant, “unit for fossil fuel<unit for alternative fuel” (difference in the units is big) applies, and that the unit for the CO₂ emission rights trading is high. The CO₂ emission rights trading initial assignment <1> is constant.

Since the difference in the units for the fossil fuel and alternative fuel is big, the cost <2>, if the cost increase by the use of the alternative fuel is set lower in consideration of the difference in the units, increases as the use rate of the alternative fuel increases, exhibiting a more gently rising trend than in FIG. 5 and FIG. 6.

The CO₂ emission amount <3> resulting from investing the alternative fuel is calculated by the processing procedure shown in FIGS. 3 and 4, and exhibits a falling curve <3> to the contrary to the use ratio of the alternative fuel.

If the CO₂ emission amount <3> resulting from investing the alternative fuel exceeds the CO₂ emission rights trading initial assignment <1>, it becomes necessary to purchase additional CO₂ emission rights. The cost needed for this purchase is as shown by the curve <5>.

On the other hand, if the CO₂ emission amount <3> resulting from investing the alternative fuel does not exceed the CO₂ emission rights trading initial assignment <1>, the unused emission rights (surplus) can be utilized for the CO₂ emission rights sale. The cost needed for this sale is as shown by the curve <4>.

The cost resulting from the difference in the units for the fuel and difference in the units for the CO₂ emission rights under these circumstances are represented by the curve <6> when the CO₂ emission rights purchase cost is taken into account by adding the above increased and decreased costs <4> and <5> to the cost increase resulting from the use of the alternative fuel <2>, and by the curve <7> when the CO₂ emission rights sale cost is taken into account.

Using the fuel cost calculation formulas given by the steps 491 and 492 in the processing procedure shown in FIG. 4, the position at which the fuel cost becomes the minimum can be found at the lowest point Q of a line PQR on the curves <6> and <7> in FIG. 8.

### Embodiment 5

In the case that “unit for fossil fuel≧unit for alternative fuel” (difference in the units is small) applies and the unit for the CO₂ emission rights trading is high:

FIG. 9 is a diagram showing the relationships of the CO₂ emission rights trading initial assignment <1>, cost increase resulting from the use of the alternative fuel <2>, CO₂ emission amount resulting form the use of the alternative fuel <3>, income of the CO₂ emission rights purchase and sale <4>, cost on the excess resulting from the CO₂ emission rights purchase <5>, cost <6>, and total cost <7> based on the condition that the target quantity of the electric power generation is constant, “unit for fossil fuel≧unit for alternative fuel” (difference in the units is small) applies, and that the unit for the CO₂ emission rights trading is low. The CO₂ emission rights trading initial assignment <1> is constant.

In this embodiment, since the unit for the alternative fuel is lower than the unit for the fossil fuel, the cost further decreases as more alternative fuel is used. That is to say, since the difference in the units for the fossil fuel and alternative fuel is small, the cost <2>, if the cost increase by the use of the alternative fuel is set higher in consideration of the difference in the units, decreases as the use rate of the alternative fuel increases, exhibiting a falling trend.

The CO₂ emission amount <3> resulting from investing the alternative fuel is calculated by the processing procedure shown in FIGS. 3 and 4, and exhibits a falling curve <3>.

If the CO₂ emission amount <3> resulting from investing the alternative fuel exceeds the CO₂ emission rights trading initial assignment <1>, it becomes necessary to purchase additional CO₂ emission rights. The cost needed for this purchase is as shown by the curve <5>.

On the other hand, if the CO₂ emission amount <3> resulting from investing the alternative fuel does not exceed the CO₂ emission rights trading initial assignment <1>, the unused emission rights (surplus) can be utilized for the CO₂ emission rights sale. The cost needed for this sale is as shown by the curve <4>.

The cost resulting from the difference in the units for the fuel and difference in the units for the CO₂ emission rights under these circumstances are represented by the curve <6> when the CO₂ emission rights purchase cost is taken into account by adding the above increased and decreased costs <4> and <5> to the cost reduction resulting from the use of the alternative fuel <2>, and by the curve <7> when the CO₂ emission rights sale cost is taken into account.

Using the fuel cost calculation formulas given by the steps 491 and 492 in the processing procedure shown in FIG. 4, the position at which the fuel cost becomes the minimum can be found at the lowest point Q of a line PQR on the curves <6> and <7> in FIG. 9. If this happens, it is necessary to set the conditions again.

According to the CO₂ emission rights trading initial assignment, the following two cases may also happen.

One is Case 1, where the CO₂ emission rights trading initial assignment is big and completely exceeds the CO₂ emission amount resulting from the use of the alternative fuel, and so the curves do not cross with each other. In this case, only the CO₂ emission rights sale is considered.

The other is Case 1, where the CO₂ emission rights trading initial assignment is small and completely falls below the CO₂ emission amount resulting from the use of the alternative fuel, and so the curves do not cross with each other. In this case, only the CO₂ emission rights purchase is considered.

The guidance device 88 installed in the fuel information management company 93 has a function of displaying the status of the calculations in FIG. 5 to FIG. 9, information data such as each fuel price and electric power pride, and output result such as cost in calculating the effect of inventing the alternative fuel such as DME.

According to the embodiment 1, the transmission company 92 can receive the operating plan for mixing the alternative fuel at the ratio of mixture at which the fuel cost, when the CO₂ emission rights trading is taken into account, is lower than in the case of using the fossil fuel only. If the company operates the plant according to the operating plan, electric power can be generated at lower cost than in the case of using the fossil fuel only. In addition, since the total mass of CO₂ contained in the exhaust gas discharged from the boiler unit 130 decreases because of the use of the alternative fuel, the volume of CO₂ that cannot be completely removed by the NOx removal system 202 and discharged into the outside air can be reduced, and so clean power generation with careful attention to the environment can be realized.

On the other hand, the fuel supply company 91 is assured of stable demand because the transmission company 92 turns to purchase the alternative fuel more frequently. As a result, it becomes possible for the fuel supply company 91 to mass-produce the alternative fuel in multiple plants at lower cost, and accordingly can attain stable profit. Since, the production cost goes down as the supply becomes stable as a result of the mass production, demand of the transmission company 92 further increases. Thus, a favorable cycle is made and maintained.

### Embodiment 2

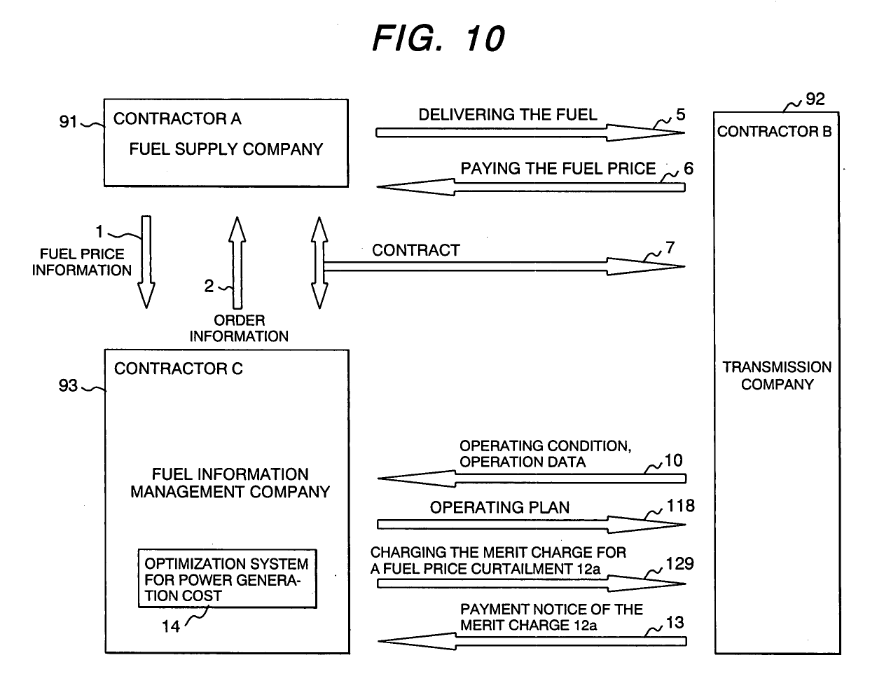

FIG. 10 is a block diagram showing the flow of the fuel, information and payment in the support system for generating company according to the present invention. In the support system for generating company of the embodiment 2, the fuel supply company 91, transmission company 92 and fuel information management company 93 conclude a contract 7 in terms of the flow of the fuel, information and payment.

According to the contract 7, the fuel information management company 93 meets both the request from the fuel supply company 91 for securing the alternative fuel supplier and the request from the transmission company 92 for supplying the alternative fuel stably at lower price at the same time, and encourages the transmission company 92 to switch over from the fossil fuel to the alternative fuel so as to reduce CO₂.

The fuel supply company 91 sells the alternative fuel such as DME that substituted for the fossil fuel.

The transmission company 92 generates electric power, using the fossil fuel and alternative fuel, and sell the generated electric power.

The fuel information management company 93 receives the operating condition and present operation data 10 of the power generation plant from the transmission company 92, and receives the fuel price information 1 from the fuel supply company 91. The fuel information management company 93, using the optimization system for power generation cost 14 and based on the above data and information, finds out the mixture rate of the fossil fuel and alternative fuel at which the fuel cost in the power generation plant of the transmission company 92 becomes lowest possible, forms an operating plan for operating the power generation plant at the mixture rate, and transfer the operating plan 118 to the transmission company 92. The fuel information management company 93 orders the alternative fuel 2 from the fuel supply company 91 in a volume necessary for the operation at the mixture rate. The fuel supply company 91 then delivers the ordered alternative fuel 5 to the transmission company 92.

The transmission company 92 pays the price 6 of the delivered fuel 5 to the fuel supply company 91.

The fuel information management company 93 calculates the fuel cost reduction achieved by a mixing combustion operating plan 118, operating cost reduction of the NOx removal system of the exhaust gas, that is, reduction of the reducing agent cost and reduction of the power for the NOx removal fan, and operating cost reduction of the crushers and grinding mill, that is, reduction of the crushers and grinding mill power, and charges 129 the price, which is the cost reduction above multiplied by a pre-specified coefficient, as a merit charge for a fuel price curtailment 12a to the transmission company 92.

The transmission company 92 makes a payment 13 of the merit charge 12a to the fuel information management company 93.

The fuel information management company 92 always checks the equipment 8a for malfunction, based on the operating data 10 of the power generation plant received from the transmission company 92. If any malfunction is found in the equipment 8a, the fuel information management company 93 finds out an operation method for avoiding the malfunction and sends it, as the operating plan 118, to the operation control device in the power generation plant.

The optimization system for power generation cost 14 communicates with the transmission company 92 and reads out the target power generation output and the fossil fuel consumption, alternative fuel consumption, utility consumption of the NOx removal system for a pre-specified number of days, for example, for a day. The fossil fuel consumption and alternative fuel consumption are the volume of the fossil fuel and alternative fuel that the operation control device 33 actually supplies to the boiler unit 130 by controlling the supply volume adjustment equipments 113 and 122. The utility consumption of the NOx removal system is the volume of ammonia that the operation control device 33 instructs the NOx removal system 202 to invest according to the NOx concentration detected by the exhaust gas sensor 34.

The operation control device 33 at the transmission company 92 receives the operating plan sent from the optimization system for power generation cost 14 at the fuel information management company 93, and controls the plant equipment of the power generation plan according to the operating plan. In this embodiment 2, the opening of each valve constituting the supply volume adjustment equipmentes 113, 122 and 161 is received as the operating plan and the supply volume adjustment equipmentes 113, 122 and 161 are controlled according to the opening.

The transmission company 92 supplies the fossil fuel and alternative fuel to the boiler unit 130 at the determined use rate α of the alternative fuel and also supplies a suitable volume of air to achieve a specified power generation output.

Of the measurement data of the plant equipment of the power generation plant, the transmission company 92 sends the actual fossil fuel consumption, alternative fuel consumption, and utility consumption of the NOx removal system, that is, the volume of ammonia used in the NOx removal system to the optimization system for power generation cost 14 at the fuel information management company 93.

With the support system for generating company according to the embodiment 2, the transmission company 92 can operate the plant by mixing the alternative fuel at the ratio of mixture at which the fuel cost, when the CO₂ emission rights trading is taken into account, is lower than in the case of using the fossil fuel only. Accordingly, when the company operates the plant according to the operating plan, electric power can be generated at lower cost than in the case of using the fossil fuel only.

In addition, since the total mass of CO₂ contained in the exhaust gas discharged from the boiler unit 130 decreases, clean power generation with careful attention to the environment can be realized.

Since the fuel supply company 91 is assured of stable demand because the transmission company 92 turns to purchase the alternative fuel more frequently, it becomes possible for the fuel supply company 91 to mass-produce the alternative fuel in multiple plants at lower cost, and accordingly can attain stable profit.

(Effects of the Invention)

According to the present invention, the fuel cost of a power generation plant can be optimized because the effect of investing the alternative fuel in the power generation plant is calculated, by comparing with the initially formed synthesis fuel invest plan, based on the information including the fossil fuel price, alternative fuel price, electric power price, and pre-specified CO₂ emission rights price, taking into account the use of the alternative fuel, such as DME, and CO₂ emission rights purchase and sale.

What is claimed is:

1. An optimization method for power generation cost;
the method assuming the mixture rate of alternative fuel and calculating the fuel cost for achieving a target power generation output based on, at least, the fossil fuel price, alternative fuel price, electric power price, and CO₂ emission rights price for trading;
calculating the fuel cost in the case of using fossil fuel only; and
determining the ratio of mixture of the alternative fuel at which the fuel cost in the case of mixing the alternative fuel is lower than the fuel cost in the case of using the fossil fuel only.

2. The optimization method for power generation cost as set forth in claim 1, wherein the procedure of assuming the mixture rate of the alternative fuel and calculating the fuel cost:
forms the zero-order synthesis fuel invest plan that specifies the initial mixture rate of the fossil fuel and alternative fuel;
calculates the fuel cost based on the fossil fuel price, alternative fuel price, electric power price, and CO₂ emission rights price for trading;
judges whether the result of the fuel cost calculation has reached the optimum cost; and,
if not yet reached, modifies the nth-order synthesis fuel invest plan and forms the (n+1)th-order synthesis fuel invest plan; and
re-inputs the plan into the calculating procedure; and,
if the result has reached the optimum cost, outputs an operating plan meeting the fuel cost.

3. The optimization method for power generation cost as set forth in claim 1 or 2, wherein the procedure of assuming the mixture rate of the alternative fuel and calculating the fuel cost calculates;
in the case of CO₂ emission rights purchase,
Fuel cost=Alternative fuel consumption×Unit for alternative fuel+Fossil fuel consumption×Unit for fossil fuel+Emission rights trading displacement×Unit for emission rights trading; and
in the case of CO₂ emission rights sale,
Fuel cost=Alternative fuel consumption×Unit for alternative fuel+Fossil fuel consumption×Unit for fossil fuel−Emission rights trading displacement×Unit for emission rights trading

4. An optimization system for power generation cost, comprising:
a fuel price database for storing, at least, the fossil fuel price, alternative fuel price, electric power price, and CO₂ emission rights price for trading;
planning means for forming the zero-order synthesis fuel invest plan that specifies the initial mixture rate of the fossil fuel and alternative fuel;
calculating means for calculating the fuel cost based on the prices such as fuel prices in the database; and
evaluation method for judging whether the result of the fuel cost calculation has reached the optimum cost, and, if not yet reached, modifying the nth-order synthesis fuel invest plan, forming the (n+1)th-order synthesis fuel invest plan, and re-inputting the plan into the calculating means, and if the result has reached the optimum cost, outputting an operating plan meeting the fuel cost.

5. The optimization system for power generation cost as set forth in claim 4, wherein
the calculating means includes a means for calculating;
in the case of CO₂ emission rights purchase,
Fuel cost=Alternative fuel consumption×Unit for alternative fuel+Fossil fuel consumption×Unit for fossil fuel+Emission rights trading displacement×Unit for emission rights trading; and
in the case of CO₂ emission rights sale,
Fuel cost=Alternative fuel consumption×Unit for alternative fuel+Fossil fuel consumption×Unit for fossil fuel−Emission rights trading displacement×Unit for emission rights trading

6. The optimization system for power generation cost as set forth in claim 4 or 5, wherein
the calculating means includes a means for calculating, using, as A1, a variable that bases on the change in the efficiency of a power generation plant resulting from the invest of alternative fuel,
Fuel consumption=A1×Alternative fuel consumption+Fossil fuel consumption

7. The optimization system for power generation cost as set forth in any one of claims 4 to 6, wherein
the calculating means includes a means for calculating, using, as the basic fuel consumption, the fossil fuel consumption in the case the fuel consumption comprises 100% fossil fuel, and, as K2, a proportional constant that depends upon the special characteristic of a plant,
Basic emission amount=K2×Basic fuel consumption;
calculating, using, as K3, a proportional constant that depends upon the special characteristic of a plant,
Hazardous substance emission amount reduction=K3×Alternative fuel consumption; and
calculating
Hazardous substance actual emission amount=Basic emission amount−Emission amount reduction

8. The optimization system for power generation cost as set forth in any one of claims 4 to 7, wherein
the calculating means includes a means for calculating,
using, as the emission rights share, the hazardous substance emission amount that is permitted under the distributed free-of-charge CO₂ emission rights, in the case of “actual emission amount>emission rights distribution share”,
Emission rights purchase amount=(Actual emission amount−Emission rights distribution share); and, in the case of “actual emission amount ≦emission rights share”,
Emission rights purchase amount=0

9. A support system for generating company, comprising a fuel supply company who sells fossil fuel and alternative fuel, transmission company who sells the electric power that is generated using the fossil fuel and alternative fuel, and fuel information management company, wherein
the fuel information management company owns an optimization system for power generation cost, comprising a fuel price database for storing, at least, the fossil fuel price, alternative fuel price, electric power price, and CO₂ emission rights price for trading, received from the fuel supply company, planning means for forming the zero-order synthesis fuel invest plan that specifies the initial mixture rate of the fossil fuel and alternative fuel, calculating means for calculating the fuel cost based on the prices such as fuel prices in the database; and evaluation method for judging whether the result of the fuel cost calculation has reached the optimum cost, and, if not yet reached, modifying the nth-order synthesis fuel invest plan, forming the (n+1)th-order synthesis fuel invest plan, and re-inputting the plan into the calculating means, and if the result has reached the optimum cost, outputting an operating plan meeting the fuel cost;
transfers the operating plan to the transmission company, and orders the alternative fuel from the fuel supply company in a volume necessary for the operation at the mixture rate;
the fuel supply company delivers the ordered alternative fuel to the transmission company; and
the transmission company generates electric power according to the transferred operating plan, and pays a merit charge for a fuel price curtailment, which is the fuel cost reduction multiplied by a pre-specified coefficient, to the fuel information management company.

10. The support system for generating company as set forth in claim 9, wherein the optimization system for power generation cost owned by the fuel information management company comprises a fuel price database for storing, at least, the fossil fuel price, alternative fuel price, electric power price, and CO₂ emission rights price for trading, planning means for forming the zero-order synthesis fuel invest plan that specifies the initial mixture rate of the fossil fuel and alternative fuel, calculating means for calculating the fuel cost based on the prices such as fuel prices in the database; and evaluation method for judging whether the result of the fuel cost calculation has reached the optimum cost, and, if not yet reached, modifying the nth-order synthesis fuel invest plan, forming the (n+1)th-order synthesis fuel invest plan, and re-inputting the plan into the calculating means, and if the result has reached the optimum cost, outputting an operating plan meeting the fuel cost.

11. The support system for generating company as set forth in claim 9 or 10, wherein
the optimization system for power generation cost includes a means for calculating, in the case of CO₂ emission rights purchase,
Fuel cost=Alternative fuel consumption×Unit for alternative fuel+Fossil fuel consumption×Unit for fossil fuel+Emission rights trading displacement×Unit for emission rights trading; and
calculating, in the case of CO₂ emission rights sale,
Fuel cost=Alternative fuel consumption×Unit for alternative fuel+Fossil fuel consumption×Unit for fossil fuel−Emission rights trading displacement×Unit for emission rights trading.
